(19) United States
(12) Patent Application Publication
(10) Pub. No.: US 2009/0016523 A1
(43) Pub. Date: Jan. 15, 2009

(54) Masking and Additive Decomposition Techniques for Cryptographic Field Operations

(75) Inventors: Vincent Dupaquis, Biver (FR); Michel Douguet, Marseille (FR)

Correspondence Address: FISH & RICHARDSON P.C., PO BOX 1022, MINNEAPOLIS, MN, 55440-1022, US

(73) Assignee: ATMEL Corporation, San Jose, CA (US)

(21) Appl. No.: 11/777,186

(22) Filed: Jul. 12, 2007

(51) Int. Cl. H04L 9/28; G06F 7/58

(52) U.S. Cl. 380/28; 708/250

(57) ABSTRACT

Masking and additive decomposition techniques are used to mask secret material used in field operations (e.g., point multiplication operations) performed by cryptographic processes (e.g., elliptic curve cryptographic processes). The masking and additive decomposition techniques help thwart “side-channel” attacks (e.g., power and electromagnetic analysis attacks).

### TECHNICAL FIELD

The subject matter of this application is generally related to cryptography.

### BACKGROUND

Cryptographic processes are subject to “side-channel” attacks (e.g., power and electromagnetic analysis attacks) that exploit information leaked into the operating environment of a device while the device executes cryptographic algorithms. For example, a hacker may monitor the power consumed or the electromagnetic radiation emitted by a device (e.g., a smart card), while it performs private-key operations such as decryption and signature generation. The hacker may also measure the time it takes to perform a cryptographic operation, or analyze how a cryptographic device behaves when certain errors are encountered. Some conventional countermeasures to side-channel attacks insert “dummy” cryptographic operations (e.g., doubling, addition), so that the operations cannot be distinguished from each other when viewed on a power trace, for example. Inserting additional “dummy” operations, however, slows down the overall cryptographic process, which may be unacceptable for certain applications.

### SUMMARY

Masking and additive decomposition techniques are used to mask secret material used in field operations (e.g., point multiplication operations) performed by cryptographic processes (e.g., elliptic curve cryptographic processes). The masking and additive decomposition techniques help thwart “side-channel” attacks (e.g., power and electromagnetic analysis attacks).

In some implementations, a method includes: obtaining secret material; obtaining a masking parameter; and generating ciphertext or a digital signature using at least one field operation on the secret material, where the secret material and the masking parameter are combined and the field operation operates on the combination.

In some implementations, a method includes: representing a plaintext message as a point on an elliptic curve; obtaining an exponent value; obtaining a masking parameter; obtaining an order of a prime cyclic subgroup of the elliptic curve; and generating ciphertext from the point, the order, the exponent value and the masking parameter using at least one point multiplication operation, where the point multiplication operation uses the masking parameter to mask the exponent value, such that the exponent value can not be determined from an analysis of the operating environment of the cryptographic method.

In some implementations, a method includes: obtaining public domain parameters; obtaining a masking parameter; and generating ciphertext or a digital signature from the public domain parameters, the masking parameter and secret material.

In some implementations, an apparatus includes a random number generator configurable for generating a masking parameter. An encryption engine is coupled to the random number generator and configurable for generating ciphertext or a signature using at least one field operation on secret material, where the secret material and the masking parameter are combined and the field operation operates on the combination.

In some implementations, an apparatus includes a storage device for storing a masking parameter. An encryption engine is coupled to the storage device and configurable for generating ciphertext or a signature using at least one field operation on secret material, where the secret material and the masking parameter are combined and the field operation operates on the combination.

In some implementations, an apparatus includes: an interface configurable for receiving ciphertext or a signature. A decryption engine is coupled to the interface and configurable for generating plaintext from the ciphertext or authenticating the signature using at least one field operation on secret material, where the ciphertext or signature was generated using secret material and a masking parameter that were combined in a field operation used in generating the ciphertext or signature.

In some implementations, a method includes: obtaining secret material; decomposing the secret material into two or more parts; and generating ciphertext or a digital signature using at least one field addition operation on the two or more parts.

Other implementations of masking and additive decomposition techniques for field operations used in cryptographic processes are disclosed, including implementations directed to systems, methods, processes, apparatuses and computer-readable mediums.

### DESCRIPTION OF DRAWINGS

FIG. 1A is a block diagram of an implementation of a public key cryptographic system.

FIG. 1B is a flow diagram of an implementation of a cryptographic process using masking and/or additive decomposition.

FIG. 2A is a flow diagram of an implementation of an ElGamal elliptic curve encryption process using exponent masking when performing point multiplications.

FIG. 2B is a flow diagram of an implementation of an ElGamal elliptic curve decryption process.

FIG. 3A is a flow diagram of an implementation of an ElGamal elliptic curve encryption process using additive exponent decomposition when performing point multiplications.

FIG. 3B is a flow diagram of an implementation of an ElGamal elliptic curve decryption process using additive exponent decomposition when performing point multiplications.

FIG. 4 is a flow diagram of an implementation of an elliptic curve digital signature generation process using exponent masking.

FIG. 5 is a block diagram of an implementation of a system for implementing the processes of FIGS. 2A, 2B, 3, and 4.

### DETAILED DESCRIPTION

### Example Cryptographic System & Process

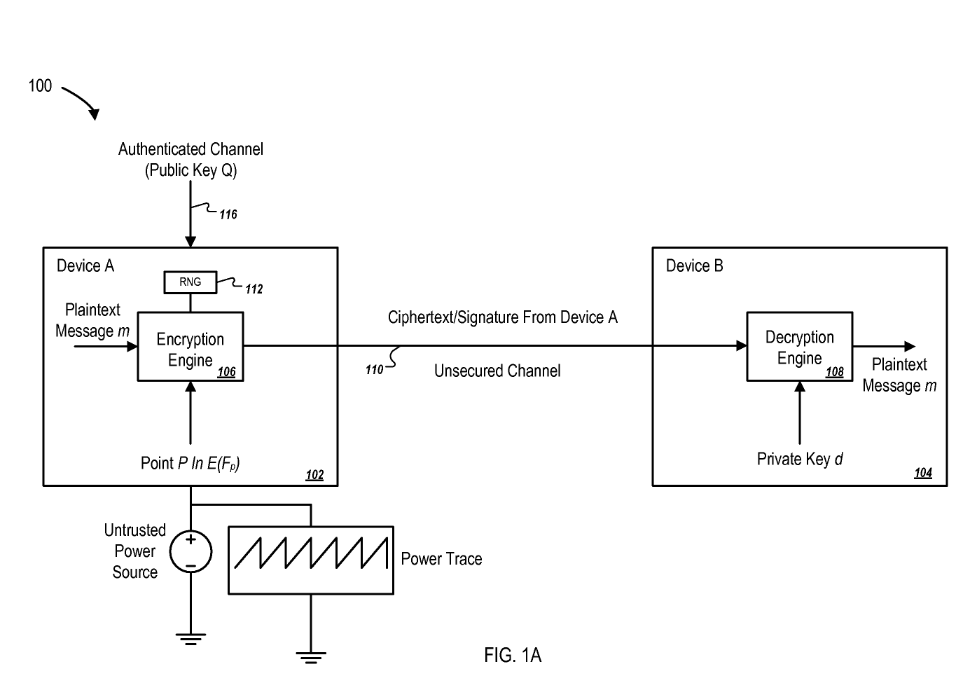

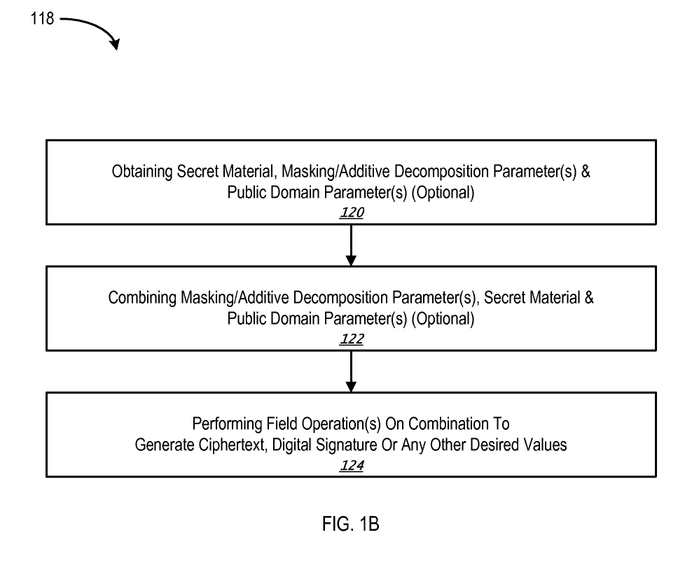

FIG. 1A is a block diagram of an implementation of a public key cryptographic system 100. The system 100 includes device 102 (“Device A”) and device 104 (“Device B”). In the example shown, device 102 can communicate with device 104 over an unsecured channel 110. For example, device 102 can send a message over the unsecured channel 110 to device 104. Devices 102 and 104 can be any device capable of performing cryptographic processes, including but not limited to: a personal computer, a mobile phone, an email device, a game console, a personal digital assistant (PDA), etc. An unsecured channel 110 can be any communication medium, including but not limited to: radio frequency (RF) carriers, optical paths, circuit paths, networks (e.g., the Internet), etc.

In some implementations, the device 102 includes an encryption engine 106 and a random number generator 112. The random number generator can generate true random numbers (e.g., generated from a physical process) or pseudo random numbers (e.g., generated from an algorithm). In other implementations, the random numbers are received through an interface or are stored on the device 102 (e.g., in memory).

In some implementations, the device 104 includes a decryption engine 108 for decrypting ciphertext or digital signatures received from device 102. The devices 102 and 104 can include both encryption and decryption engines, 106, 108, for bi-directional communication. In the example shown, the devices 102, 104, can perform a variety of cryptographic processes, including but not limited to: elliptic curve encryption/decryption, elliptic curve digital signature generation and authentication, etc.

Although the cryptographic processes described herein are related to elliptic curves, the disclosed implementations can be used with any cryptographic processes that perform field operations where it is desirable to mask secret material that could be derived from analyzing the operating environment of the field operations.

In some implementations, the same domain parameters (e.g., selected curve, group order, etc.) are shared by both devices 102, 104.

In some implementations, device 102 can be a smart card that is in the process of authenticating its holder to device 104, which can be a mainframe computer located at a bank, for example. A smart card, which may also be referred to as a chip card or an integrated circuit card (ICC), is a pocket sized card (e.g., a credit card sized card) that can include embedded integrated circuits that hold and/or process information. The smart card may also include specific security logic. The stored and/or processed information can be secure information specific to its holder (e.g., a bank account number) that can be used to process a requested transaction by the user (e.g., a withdrawal from their bank account). The security logic can be used to protect the transmission of the user specific information between device 102 and device 104.

In some cases, a hacker may monitor the communications between device 102 and device 104 by eavesdropping on the unsecured channel 110. The hacker may have the capability to read all data transmitted over the channel, to modify transmitted data, and to inject other data into the transmission for their own benefit. For example, the hacker may attempt to read a message from sending device 102 to receiving device 104 to obtain personal information about the sender of the message (e.g., bank account number, credit card number). The hacker may also attempt to impersonate either device 102 or device 104 in the communication channel to perform certain activities that would be requested or performed by either device (e.g., withdraw money from a bank account, order merchandise to be charged to a credit card).

In other cases, a hacker may try to analyze the operating environments of the devices 102 and 104 to determine secret keying material. These attacks are often referred to as “side-channel” attacks. Some examples of side-channel attacks include power analysis attacks (e.g., simple or differential) and electromagnetic analysis attacks.

Power analysis attacks measure power consumption of a cryptographic device, such as a smart card that draws power from an external, untrusted source. Secret keying material can be determined directly by examining a power trace from a single secret key operation. Elliptic curve point multiplication algorithms are particularly vulnerable to these types of attacks because formulas for adding and doubling points may have power traces which can be distinguished from other operations.

Electromagnetic analysis attacks measure electromagnetic (EM) signals induced by the flow of current through CMOS devices, which can be collected by placing a sensor close to the device while the device is performing cryptographic operations. The EM signals can be analyzed to determine which instructions are being executed and contents of data registers.

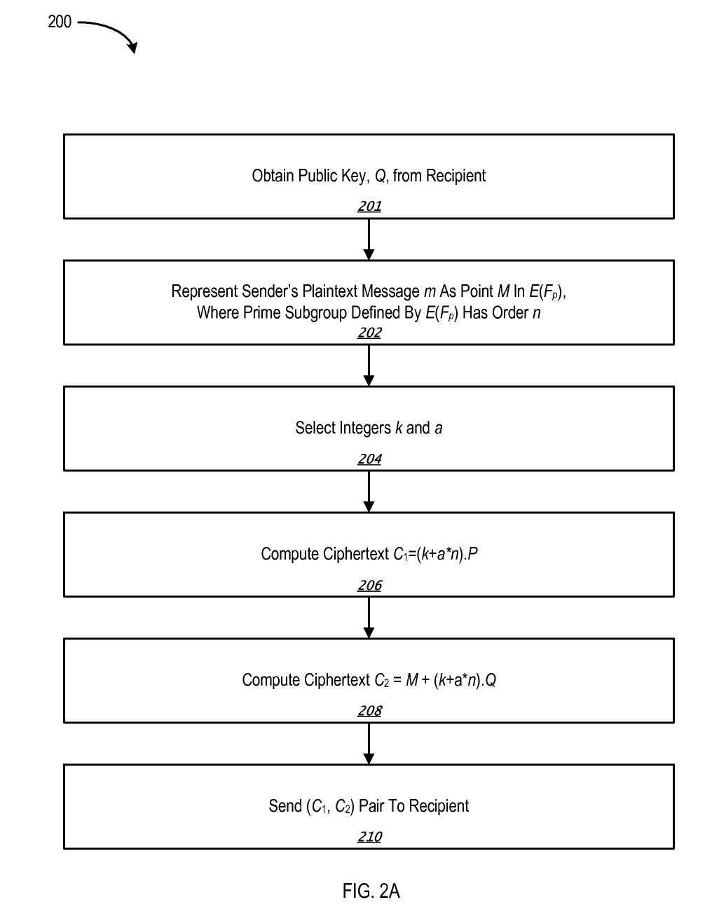

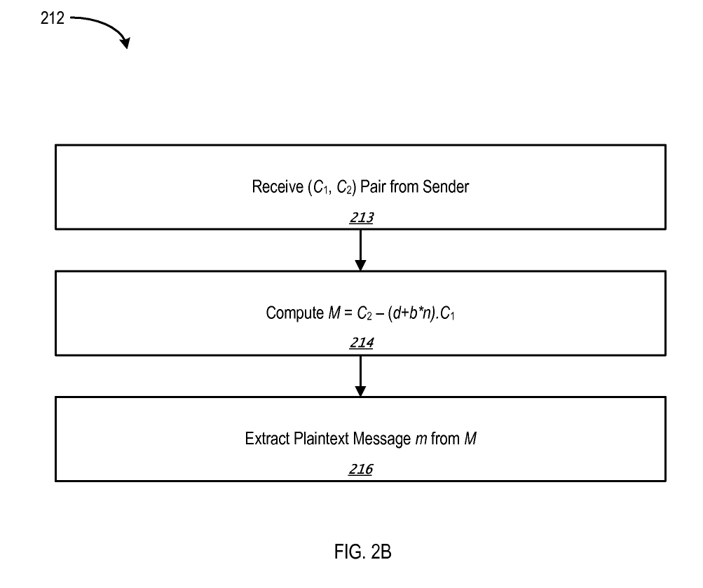

Therefore, a need may arise for secure communications between device 102 and device 104, and for securing the operating environments of devices 102 and 104. The former can be defended against using known encryption techniques. The latter can be defended against using exponent masking and additive exponent decomposition techniques, as described in reference to FIGS. 2-5.

FIG. 1B is a flow diagram of an implementation of a cryptographic process 118 using masking and/or additive decomposition. In some implementations, the process 118 begins by obtaining secret material, masking or additive decomposition parameters and, optionally, one or more public domain parameters (120). The secret material can be, for example, an exponent k used in an elliptic curve public key cryptographic system. Examples of masking and additive decomposition parameters are described in reference to FIGS. 2-4. The masking or additive decomposition parameters and, optionally, one or more public domain parameters, can be combined with the secret material (122). Examples of combinations are described in reference to FIGS. 2-4. One or more field operations (e.g., point multiplication operations) can be performed on the combination to generate ciphertext, a digital signature or any other desired value (124). The process 118 serves to mask or hide the secret material from hackers who analyze the operating environment of the cryptographic system to deduce the secret material.

### Elliptic Curve Key generation

In some implementations, cyclic subgroups of elliptic curve groups that form an additive abelian group can be used to implement the public key cryptographic system 100 based on a discrete logarithm problem. In this implementation, an elliptic curve, E, can be defined over a finite field of integers, Fₚ. A point, P, in E(Fₚ) can have a prime order, n. The cyclic subgroup of E(Fₚ) generated by point P can be defined by the following equation:

(P)={O, P, 2P, 3P, . . . (n−1)P},

where O is the point at infinity and the identity element.

In this implementation, the prime number, p, the equation of the elliptic curve, E, (e.g., the values of a and b in equation y²=x³+ax+b), the point, P, and the order, n, can be the public domain parameters. A private key, d, can be a random integer selected from the interval [1, n−1], and a corresponding public key, Q, can be calculated as: Q=d.P, where point, P, is multiplied by the private key, d, an integer, using elliptic curve point multiplication, which can be denoted by the operator “.”. For example, let A be a point on an elliptic curve. An integer, j, can be multiplied with the point A to obtain another point B on the same elliptic curve. Point multiplication can be represented by the equation: B=j.A. In some implementations, point multiplication can be performed using point addition and point doubling repeatedly to find the result. For example, if j=23, then j.A=23.A=2(2(2(2*A)+A)+A)+A, where “*” represents integer multiplication.

The problem of determining the private key, d, given the domain parameters (p, E, P, and n) and public key, Q, is referred to as the elliptic curve discrete logarithm problem (ECDLP).

### Examples of Elliptic Curve Cryptographic Processes

Exponent masking and additive exponent decomposition techniques will now be described in the context of elliptic curve point multiplication operations used in well-known elliptic curve cryptographic processes. These techniques, however, can be used in any cryptographic processes or applications where elliptic curve point multiplication operations are performed, and for which it is desirable to mask secret keying material.

### ElGamal Cryptographic Processes

In some implementations, the public key cryptographic system 100 can use an elliptic curve analogue of ElGamal encryption and decryption processes. For example, a public key, Q, can be the public key of device 104, the receiving device. Device 102, the sending device, can acquire the public key, Q, from device 104 via authenticated channel 116. A plaintext message m can be represented as a point, M, in a finite field of integers E(Fₚ). Encryption engine 106 can compute ciphertext C₁, where C₁ is a point on E(Fₚ), using the following equation:

C₁=k.P,

where k is a random number selected by device 102 from the interval [1, (n−1)], and P is a point in E(Fₚ) and is a domain parameter.

Encryption engine 106 can also compute ciphertext C₂, where C₂ is a point in E(Fₚ), using the following equation:

C₂=M+k.Q,

where M is the point representation of the plaintext message m and Q is the point representation of the public key of device 104, where point Q is in E(Fₚ).

The ciphertext pair of points (C₁, C₂) can be transmitted by device 102 to device 104 over unsecured channel 110. Device 104, using decryption engine 108 and its private key d, can recover the plaintext message m from the ciphertext pair of points (C₁, C₂) using the following equation:

M=C₂−d.C₁,

where M is the point representation of the plaintext message m, d is the private key of device 104, and plain text message m can be extracted from M.

A hacker analyzing the operating environments of the devices 102, 104 would need to compute k.Q, since d.C₁=k.Q. The task of computing k.Q from the domain parameters (e.g., p, E, P, n), public key Q, and C₁=k.P can be referred to as the elliptic curve analogue of the Diffie-Hellman problem. Since Q is a public domain parameter, the hacker need only determine the exponent k from the operating environment to recover the plaintext message m. Thus, it is desirable to protect the exponent k from side-channel attacks.

### Elliptic Curve Encryption Process Using Exponent Masking

FIG. 2A is a flow diagram of an implementation of an ElGamal elliptic curve encryption process 200 using exponent masking when performing point multiplications. The process 200 can be an alternate implementation of an ElGamal elliptic curve encryption process. In some implementations of the ElGamal elliptic curve encryption process, for example, a random number k selected by device 102 from the interval [1, (n−1)] can be referred to as an exponent value k. This can be attributed to the solving of the Diffie-Hellman problem (DHP) to determine the value of k.

The process 200 begins with a sender (e.g., device 102) obtaining a public key, Q, from a recipient (e.g., device 104) over an authenticated channel (e.g., channel 116) between the sender and the recipient (step 201). The sender can represent its plaintext message m as a point M on an elliptic curve, E, which can be defined over a finite field, Fₚ, where p is a prime number. The set of all points on the elliptic curve E can be denoted as E(Fₚ), which defines a prime subgroup of order n (step 202). The sender can then select a random number k from the interval [1, (n−1)] (step 204). The sender can also select a random number, a, where a is greater than or equal to 1 (step 204). The random number a can be referred to as a masking parameter. The masking parameter a can be an integer or a function, which can be evaluated by one or more values before being multiplied by the order n.

The sender can compute ciphertext point C₁ (step 206) using the following equation:

C₁=(k+a*n).P,

where P is a point in E(Fₚ).

The sender can compute ciphertext point C₂ (step 208) using the following equation:

C₂=M+(k+a*n).Q.

The sender can transmit the ciphertext pair of points (C₁, C₂) to the recipient (step 210) over an unsecured channel (e.g., channel 110).

### Elliptic Curve Decryption Process

FIG. 2B is a flow diagram of an implementation of an ElGamal elliptic curve decryption process 212 when performing point multiplications. The process 212 can be used as the decryption process for use with the elliptic curve encryption process 200. The process 212 begins when the recipient receives the ciphertext pair of points (C₁, C₂) from the sender over an unsecured channel (e.g., channel 110) (step 213). The recipient then computes the point representation, M, of a plaintext message (step 214) using the following equation:

M=C₂−(d+b*n).C₁,

where d is the private key of the recipient device, b is a masking parameter and n is an order of a prime subgroup. Note that the masking parameter b can be different than the masking parameter a used to generate the ciphertext.

Knowing M, the recipient can then extract the plaintext message m from its point representation, M, as described above (216).

As can be observed from the processes 200, 212, the exponent value k is masked by the masking parameter a, and the private key d is masked by the masking parameter b The task of computing k.Q from the domain parameters (e.g., p, E, P, n), public key Q, and C₁=k.P can be referred to as the elliptic curve analogue of the Diffie-Hellman problem, where k is the discrete logarithm of Q to the base P. The use of (k+a*n) as a substitute for k in the point multiplication of k.Q and k.P can increase the difficulty for a hacker analyzing an encrypting operating environment to recover M to determine the plaintext message m. Likewise, the use of (d+b*n) as a substitute for d in the point multiplication of d.C₁ can increase the difficulty for a hacker analyzing a decrypting operating environment to recover M to determine the plaintext message m. For example, to recover M during an encrypting operation, the hacker would need to compute (k+a*n).Q and (k+a*n).P. The hacker would need to determine the exponent k, which has been masked by the random masking parameter a. Thus, this technique has an advantage over conventional techniques in that a simple integer multiplication is performed, rather than adding additional field arithmetic operations (e.g., doubling or addition operations), which can negatively impact the performance of cryptographic processes.

### Elliptic Curve Encryption Process Using Additive Exponent Decomposition

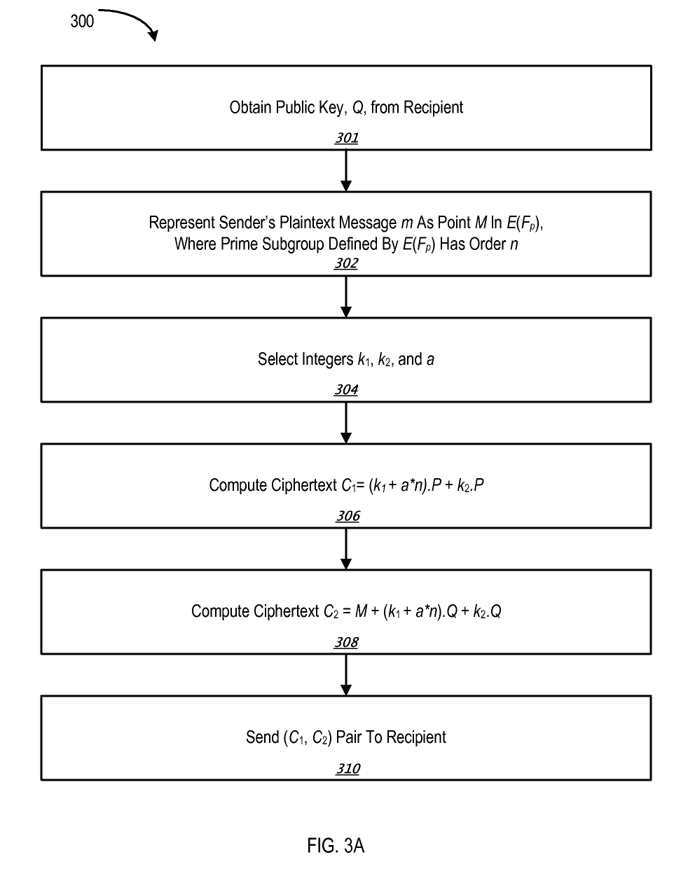

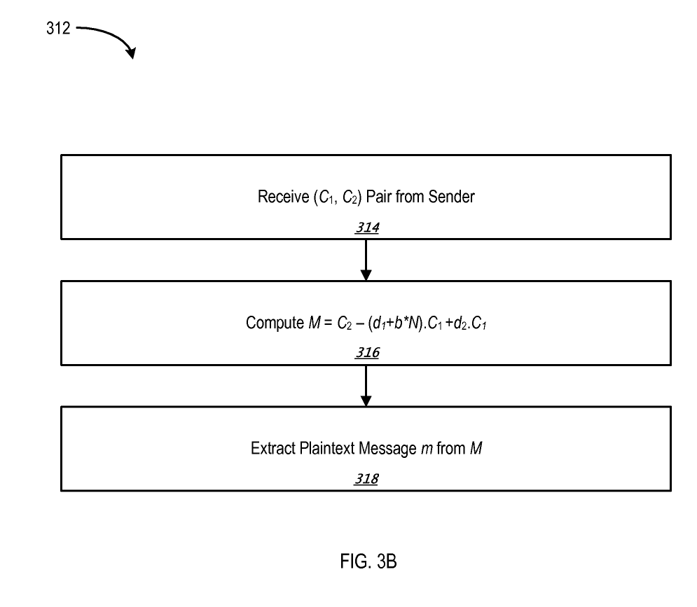

FIG. 3A is a flow diagram of an implementation of an ElGamal elliptic curve encryption process 300 using additive exponent decomposition. The process 300 can be an alternate implementation of the ElGamal elliptic curve encryption process described in reference to FIGS. 2A and 2B.

The process 300 begins with a sender (e.g., device 102) obtaining a public key, Q, from a recipient (e.g., device 104) over an authenticated channel (e.g., channel 116) between the sender and the recipient (step 301). The sender can represent its plaintext message m as a point M on an elliptic curve, E, which can be defined over a finite field, Fₚ, where p is a prime number. The set of all points on the elliptic curve E can be denoted as E(Fₚ), which defines a prime subgroup of order n (step 302). The sender can then select a random number k from the interval [1, (n−1)]. The sender can then select integers k₁ and k₂, where k=k₁+k₂ (step 304). The sender can also select a random number, a, where a is a small random number (step 304). In some implementations, a can be the result of a function that has been evaluated by one or more values.

The sender can compute ciphertext point C₁ (step 306) using the following equation:

C₁=(k₁+a*n).P+k₂.P,

where k₁ is an integer selected by the sender where k=k₁+k₂, k₂ is an integer selected by the sender where k=k₁+k₂, a is a small random number, P is a point P in E(Fₚ), and n is the order of the prime subgroup defined by E(Fₚ).

The sender can compute ciphertext point C₂ (step 308) using the following equation:

C₂=M+(k₁+a*n).Q+k₂.Q,

where M is the point representation of a plaintext message m, and Q is the public key of the recipient.

The sender can transmit the ciphertext pair of points (C₁, C₂) to the recipient (step 310) over an unsecured channel (e.g., channel 110).

A decryption process for the ciphertext pair of points (C₁, C₂) produced by process 300 can be similar to the decryption process described with reference to FIG. 2B.

The process 300 can perform an additive exponent decomposition of the number, k. As was described with reference to FIG. 2A, the substitution of k with a more complex numerical representation or value, can increase the difficulty of determining the plaintext message being transmitted between an sender and a recipient. The use of ((k₁+a*n).P+k₂.P) as a substitute for the point multiplication, k.P, and the use of ((k₁+a*n).Q+k₂.Q) as a substitute for the point multiplication, k.Q, can increase the difficulty for a hacker, eavesdropping on an unsecured channel between the sender and the receiver (e.g., channel 110), to recover M to determine the plaintext message m. To recover M, the hacker would need to compute ((k₁+a*n).P+k₂.P) and ((k₁+a*n).Q+k₂.Q). The hacker would need to determine k₁, k₂, and a. Therefore, the implementation of FIG. 3A masks the value of the exponent, k, by requiring an additive exponent decomposition of the number, k.

FIG. 3B is a flow diagram of an implementation of an ElGamal elliptic curve decryption process 312 using additive exponent decomposition when performing point multiplications.

The process 312 can be used as the decryption process for use with the elliptic curve encryption process 300. The process 312 begins when the recipient receives the ciphertext pair of points (C₁, C₂) from the sender over an unsecured channel (e.g., channel 110) (step 314). The recipient then computes the point representation, M, of a plaintext message (step 316) using the following equation:

M=C₂−(d₁+b.N).C₁+d₂.C₁,

where d is the private key of the recipient device, which is decomposed into two parts d₁ and d₂, b is a masking parameter (e.g., a small random number) and N is an order of the underlying field (e.g., an elliptic curve).

Knowing M, the recipient can then extract the plaintext message m from its point representation, M, as described above (318).

### Elliptic Curve Digital Signature Algorithm (ECDSA)

In some implementations, a digital signature algorithm (DSA) can be used in an elliptic curve based public key cryptographic system. An Elliptic Curve Digital Signature Algorithm (ECDSA) is the elliptic curve analogue of the DSA. ECDSA can be used by trusted certification authorities to sign certificates that can bind together a device and its public key.

An ECDSA can include four algorithms that can be used to generate the digital signature for a plaintext message m. The first algorithm can be a domain parameter generation algorithm that can generate a set, D, of domain parameters. The domain parameters D can include the following parameters: q, the field order; E, the elliptic curve equation (e.g., a and b in equation y²=x³+ax+b); a point, P, in E(Fₚ); the order, n, of P; and cofactor, h, where h=#E(Fₚ)/n, and #E(Fₚ) is the number of points in the elliptic curve, E.

The second algorithm can be a key generation algorithm that can take a set of domain parameters, D, and generate a key pair (e.g., Q, d).

The third algorithm can be a signature generation algorithm that can take as input a set of domain parameters, D, a private key d, and a message m, and produce a signature Σ.

The forth algorithm can take as input a set of domain parameters, D, a public key Q, a message m, and a signature Σ and can accept or reject the signature Σ.

In an implementation of ECDSA, with reference to FIG. 1A, a sender (e.g., device 102) can generate a signature and transmit it to a recipient (e.g., device 104) via an unsecured channel (e.g., channel 110). The recipient (e.g., device 104) can then verify the received signature.

The sender (e.g., device 102) can select a random number, k, from the interval [1, (n−1)]. The sender can then compute k.P=(x₁, y₁), where (x₁, y₁) is a point on the elliptic curve, E. Point coordinate x₁ can be converted to an integer, x̅₁. The sender can compute r= x̅₁ mod n, where mod is modulo operator. If r is equal to zero, the sender begins the signature generation process again and selects a random number, k. If r is not equal to zero, the sender can compute a message digest, e=H(m), using a cryptographic hash function, H, where the message digest, e, can serve as a short fingerprint of plaintext message m. The sender can then compute the following equation for s, s=k⁻¹*(e+d*r) mod n. If s is equal to zero, the sender begins the signature generation process again and selects a random number, k. If s is not equal to zero, the sender can transmit signature (r, s) to the recipient.

The recipient (e.g., device 102) can verify the received signature (r, s), and either accept the signature or reject the signature. The recipient can verify that r and s are integers in the interval [1, n−1]. If either r or s, or both r and s are not in the interval [1, n−1], the verification will fail and the signature can be rejected. If r and s are in the interval [1, n−1], the recipient can then compute the message digest, e=H(m).

Next, the recipient can compute a value, w=s⁻¹ mod n. The recipient can then compute values, u₁ and u₂, where u₁=e*w mod n, and u₂=r*w mod n. The recipient can next compute a value, X, where X=u₁.P+u₂.Q. If X is equal to infinity, the signature can be rejected. If X is not equal to infinity, the recipient can convert the x coordinate (x₁) of the point, X, to an integer, x̅₁. The recipient can compute a value, v, where v= x̅₁ mod n. If v equals r, the signature can be accepted. If v is not equal to r, the signature can be rejected. The recipient can end the signature verification process.

### Elliptic Curve Digital Signature Generation Using Exponent Masking

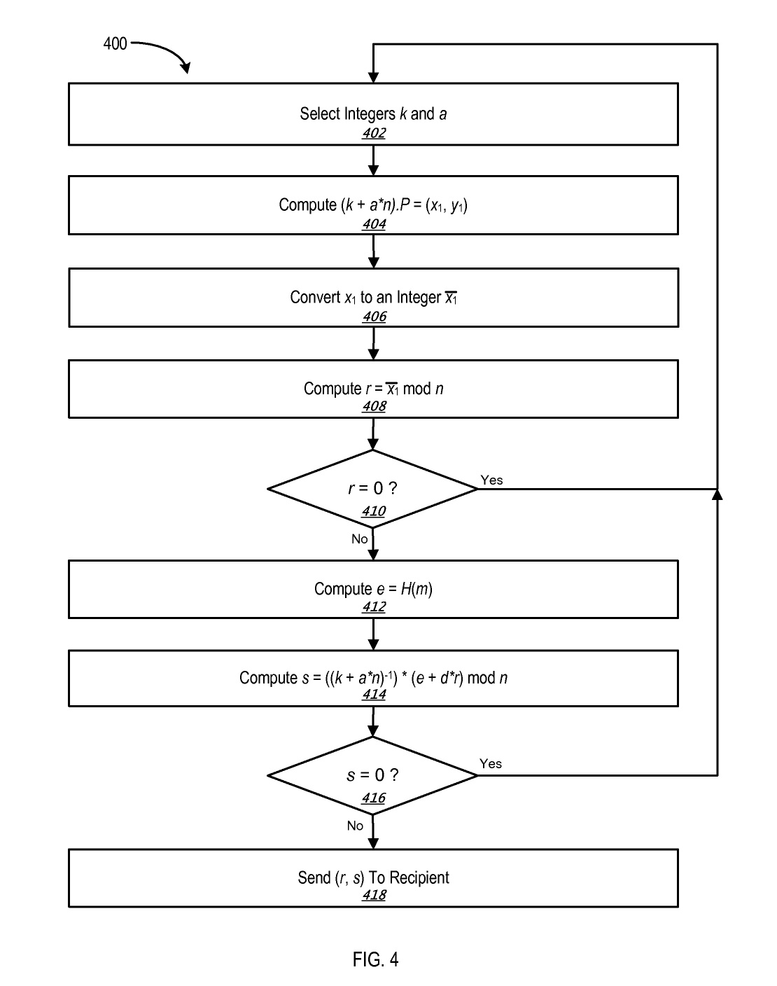

FIG. 4 is a flow diagram of an implementation of an elliptic curve digital signature generation process 400 using exponent masking when performing point multiplications. The process 400 begins when a sender (e.g., device 102) sends a message m to a recipient (e.g., device 104) which requires a digital signal from the sender for verification by the recipient. The benefits of using a digital signature for a message were previously described.

The sender can select can select a random number, k, from the interval [1, (n−1)] and a random number, a, where a is greater than or equal to 1 (step 402). To mask the exponent, (k+a*n) can be substituted for the value of k in the equations for the ECDSA. Next, in the process 400, the sender can compute (k+a*n).P=(x₁, y₁), where (x₁, y₁) is a point on the elliptic curve E (step 404). Point coordinate x₁ can be converted to an integer, x̅₁ (step 406).

The sender can compute r= x̅₁ mod n (step 408). If r is equal to zero (step 410), the sender begins the signature generation process again and selects a random numbers, k and a (step 402). If r is not equal to zero (step 410), the sender can compute a message digest, e=H(m), (step 412) using a cryptographic hash function, H, where the message digest, e, can serve as a short fingerprint of the message m being sent to the recipient (e.g., device 104) by the sender (e.g., device 102). The sender can then compute the following equation for s: s=(k+a*n)⁻¹*(e+d*r) mod n (step 414). If s is equal to zero (step 416), the sender begins the signature generation process again and selects a random numbers, k and a (step 402). If s is not equal to zero (step 416), the sender can transmit signature (r, s) along with the message to the recipient (step 418).

The recipient (e.g., device 102) can verify the received signature (r, s), and either accept the signature or reject the signature. This process was described above.

In some implementations, the equation of an elliptic curve can be on a binary field, F₂_{^{m}}. The equation can be of the form:

y²+xy=x³+ax²+b, where b≠0.

In this implementation, the elements of the finite field can be integers that have a length of, at most, m bits. The elements can be considered as a binary polynomial of degree m−1. Polynomial arithmetic can be used for addition, multiplication, division, and subtraction operations. This elliptic curve can be used in the implementations described in FIGS. 1-4.

The foregoing processes implement exponent masking and additive exponent decomposition when performing point multiplications in an ECC system. Other processes are possible, including processes with more or fewer steps. The steps of processes 200, 212, 300 and 400 need not be performed serially in the order shown. The processes 200, 212, 300 and 400 can be divided into multiple processing threads run by one or more processor cores and/or parallel processors.

### System Architecture

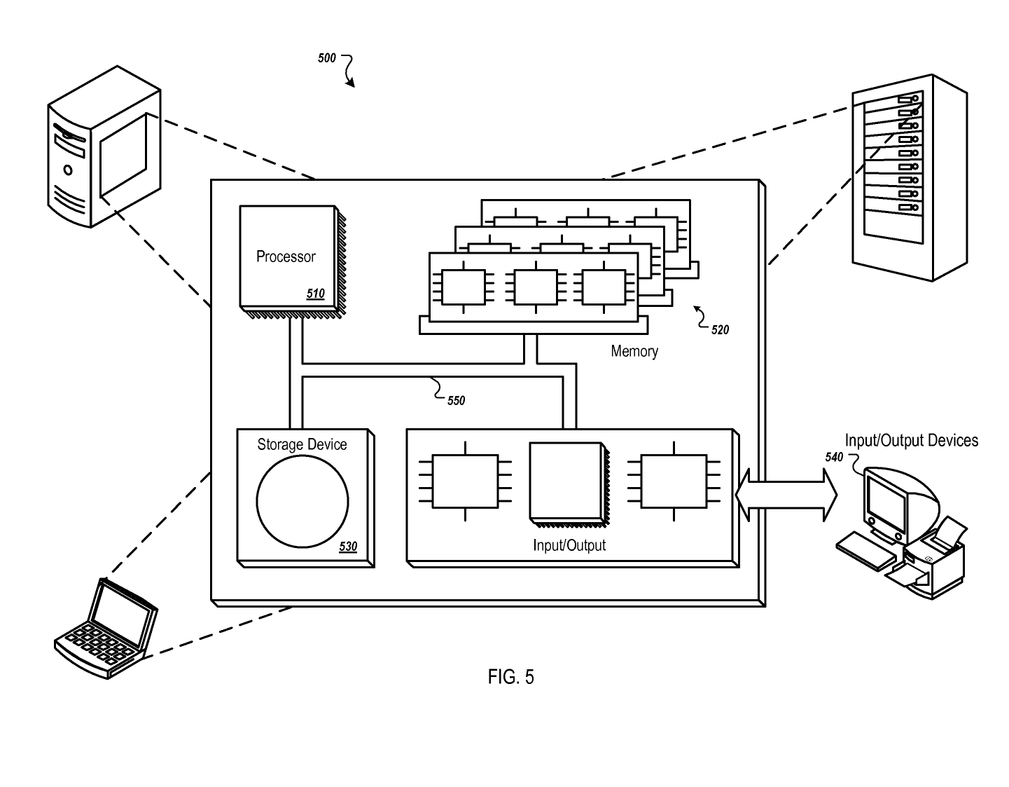

FIG. 5 is a block diagram of an implementation of a system for implementing the processes of FIGS. 2A, 2B, 3, and 4. For example, the system 500 may be included in device 102 and/or in device 104, described in reference to FIG. 1A. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In some implementations, the processor 510 is a single-threaded processor. In another implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In another implementations, the memory 520 is a volatile memory unit. In yet another implementations, the memory 520 is a non-volatile memory unit.

The storage device 530 is capable of providing mass storage for the system 500. In some implementations, the storage device 530 is a computer-readable medium. In various different implementations, the storage device 530 may be a floppy disk device, a hard disk device, an optical disk device, or a tape device.

The input/output device 540 provides input/output operations for the system 500. In some implementations, the input/output device 540 includes a keyboard and/or pointing device. In another implementations, the input/output device 540 includes a display unit for displaying graphical user interfaces.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

In some implementations, the processes described in FIGS. 2A, 2B, 3A, 3B and 4 can be executed on a microcontroller that can include specialized circuitry for a cryptographic system. In some implementations of the microcontroller, circuitry may be included for protection against simple power analysis (SPA), differential power analysis (DPA), simple electromagnetic analysis (SEMA), and differential electromagnetic analysis (DEMA) attacks. The microcontroller may also implement exponent masking (FIGS. 2A, 2B) and additive exponent decomposition (FIGS. 3A, 3B) during message encryption to further prevent attacks.

For example, the microcontroller may be included on a smart card. An example of such a microcontroller can be the Atmel AT90SC6404RFT secure microcontroller for smart cards. The circuitry of the microcontroller and related circuitry on the smart card can include thousands of logic gates that switch on and off differentially depending upon the complexity of the operations being executed. The current consumption of the smart card is dependent on the gate switching which can be determined by the operation being executed. A hacker can monitor the power consumption of the smart card, and using statistical information, can deduce information about sensitive data when it is manipulated. Therefore, any changes to the manipulation of the sensitive data that may not be included in previously gathered statistical information can prevent an attack.

SPA can involve monitoring the current consumption curve of the smart card. DPA can use statistical information to amplify and reveal power consumption differences that may not be detectable with SPA. SEMA and DEMA can involve monitoring the electromagnetic emissions of the smart card. The current consumed by the smart card can create electromagnetic fields that can be measured using a special probe. These fields can be dependent on current consumption which varies depended upon the operations being executed on the smart card. Also the electromagnetic emissions from the smart card will vary by location on the card, depending upon what chip(s) are being used to execute the operations. By monitoring not only the electromagnetic emissions of the smart card but also their location, a hacker using statistical data and reverse engineering may be able to determine sensitive data.

The use of exponent masking and additive exponent decomposition can prevent a hacker from determining the exponent, k, due to the complexity of the equations. Also, if the hacker cannot determine when the actual cryptographic process is being performed, it will be even more difficult for the hacker to determine the sensitive data being transmitted. The use of these two processes may enable a hacker, using any of the methods described above, from determining that an encryption process and transmission is even occurring.

A number of implementations have been described. Nevertheless, it will be understood that various modifications may be made. For example, elements of one or more implementations may be combined, deleted, modified, or supplemented to form further implementations. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining secret material;
obtaining a masking parameter; and
generating ciphertext or a digital signature using at least one field operation on the secret material, where the secret material and the masking parameter are combined and the field operation operates on the combination.

2. The method of claim 1, where the masking parameter is a random integer greater or equal to one.

3. The method of claim 1, where the masking parameter is generated by evaluating a function using one or more values.

4. The method of claim 1, where the secret material is a private key for an elliptic curve cryptographic process.

5. The method of claim 1, where the field operation is an elliptic curve point multiplication operation.

6. The method of claim 5, where the combination is given by k+a*n, where k is the secret material, a is the masking parameter and n is an order of an elliptic curve.

7. The method of claim 1, where the secret material is a random integer.

8. The method of claim 1, where the signature is generated in an elliptic curve digital signature process.

9. The method of claim 1, where the ciphertext is generated in an elliptic curve encryption or decryption process.

10. A method, comprising:
representing a plaintext message as a point on an elliptic curve;
obtaining an exponent value;
obtaining a masking parameter;
obtaining an order of a prime cyclic subgroup of the elliptic curve; and
generating ciphertext from the point, the order, the exponent value and the masking parameter using at least one point multiplication operation, where the point multiplication operation uses the masking parameter to mask the exponent value, such that the exponent value can not be determined from an analysis of the operating environment of the cryptographic method.

11. The method of claim 10, wherein obtaining an exponent value further comprises:
randomly generating an integer value for the exponent value from a finite field of integer values.

12. The method of claim 10, where the point multiplication replaces the exponent value with a sum of the exponent value and a product of the masking parameter and the order.

13. A method, comprising:
obtaining public domain parameters;
obtaining a masking parameter; and
generating ciphertext or a digital signature from the public domain parameters, the masking parameter and secret material.

14. The method of claim 13, where generating ciphertext or signature further comprises:
combining the masking parameter and secret material, such that the secret material is difficult to derive from observing an environment where the ciphertext or signature is generated.

15. An apparatus comprising:
a random number generator configurable for generating a masking parameter; and
an encryption engine coupled to the random number generator and configurable for generating ciphertext or a signature using at least one field operation on secret material, where the secret material and the masking parameter are combined and the field operation operates on the combination.

16. The apparatus of claim 15, where the masking parameter is a random integer greater or equal to one.

17. The apparatus of claim 15, where the masking parameter is generated by evaluating a function using one or more values.

18. The apparatus of claim 15, where the secret material is a private key for an elliptic curve cryptographic process.

19. The apparatus of claim 15, where the field operation is an elliptic curve point multiplication operation.

20. The apparatus of claim 19, where the combination is given by k+a*n, where k is the secret material, a is the masking parameter and n an order of an elliptic curve.

21. The apparatus of claim 15, where the secret material is a random integer.

22. The apparatus of claim 15, where the digital signature is generated in an elliptic curve digital signature process.

23. The apparatus of claim 15, where the ciphertext is generated in an elliptic curve encryption process.

24. The apparatus of claim 15, where the apparatus is a smart card.

25. An apparatus comprising:
a storage device for storing a masking parameter; and
an encryption engine coupled to the storage device and configurable for generating ciphertext or a signature using at least one field operation on secret material, where the secret material and the masking parameter are combined and the field operation operates on the combination.

26. An apparatus comprising:
an interface configurable for receiving ciphertext or a signature; and
a decryption engine coupled to the interface and configurable for generating plaintext from the ciphertext or authenticating the signature using at least one field operation on secret material, where the ciphertext or signature was generated using secret material and a masking parameter that were combined in a field operation used in generating the ciphertext or signature.

27. The apparatus of claim 26, where the field operation is an elliptic curve point multiplication operation.

28. The apparatus of claim 26, where the digital signature is generated in an elliptic curve digital signature process.

29. The apparatus of claim 26, where the ciphertext is generated in an elliptic curve encryption process.

30. A system comprising:
means for obtaining secret material;
means for obtaining a masking parameter; and
means for generating ciphertext or a signature using at least one field operation on the secret material, where the secret material and the masking parameter are combined and the field operation operates on the combination.

31. A computer-readable medium having instructions stored thereon, which, when executed by a processor, causes the processor to perform operations, comprising:
obtaining secret material;
obtaining a masking parameter; and
generating ciphertext or a signature using at least one field operation on the secret material, where the secret material and the masking parameter are combined and the field operation operates on the combination.

32. A method comprising:
obtaining secret material;
decomposing the secret material into two or more parts; and
generating ciphertext or a digital signature using at least one field addition operation on the two or more parts.

33. The method of claim 32, where the secret material is a private key for an elliptic curve cryptographic process.

34. The method of claim 32, where the field addition operation is an elliptic curve addition operation.

35. The method of claim 32, where the two parts, k₁, k₂, are combined to give k.A=k₁.A+k₂.A, where A is a point on an elliptic curve and k is an integer less than an order of the elliptic curve.

36. The method of claim 35, where the two parts, k₁, k₂, are combined to give k.A=(k₁+a.N).A+k₂.A, where a is a masking parameter and N is an order of the elliptic curve.

37. The method of claim 32, where the secret material is a random integer.

38. The method of claim 32, where the signature is generated in an elliptic curve digital signature process.

39. The method of claim 32, where the ciphertext is generated in an elliptic curve encryption or decryption process.

40. A computer-readable medium having instructions stored thereon, which, when executed by a processor, causes the processor to perform operations comprising:
obtaining secret material;
decomposing the secret material into two or more parts; and
generating ciphertext or a digital signature using at least one field addition operation on the two or more parts.
